(19) United States
(12) Patent Application Publication
(10) Pub. No.: US 2021/0163714 A1
(43) Pub. Date: Jun. 3, 2021

(54) GLASSFIBER-REINFORCED TPU

(71) Applicant: BASF SE, Ludwigshafen am Rhein (DE)

(72) Inventors: Oliver Steffen HENZE, Lemfoerde (DE); Tanja LANGE, Lemfoerde (DE); Birte NITZ, Lemfoerde (DE)

(73) Assignee: BASF SE, Ludwigshafen am Rhein (DE)

(21) Appl. No.: 17/258,027

(22) PCT Filed: Jul. 11, 2019
(86) PCT No.: PCT/EP2019/068677

§ 371 Date: Jan. 5, 2021

(30) Foreign Application Priority Data
Jul. 12, 2018 (EP) 18183144.7

(51) Int. Cl. C08K 7/14; C08G 18/76; C08G 18/66; C08G 18/48; C08G 18/32

(52) U.S. Cl. CPC C08K 7/14; C08G 18/7671; C08G 18/3206; C08G 18/4854; C08G 18/6674

(57) ABSTRACT

A composition may include a thermoplastic polyurethane obtained or obtainable by reaction of a polyisocyanate composition with a polyol composition, the polyol composition including at least one polyol, a chain extender, and a chain extender; and a filler. Such a composition may be made and used for producing a shaped body, and a shaped body may include such a composition.

The present invention relates to a composition comprising a thermoplastic polyurethane (TPU-1) obtained or obtainable by reaction of a polyisocyanate composition (IZ) with a polyol composition (PZ), wherein the polyol composition (PZ) comprises at least one polyol (P1), a chain extender (KV1) and a chain extender (KV2); and a filler (F1), and also a process for producing such compositions. The present invention further relates to the use of a composition according to the invention for producing a shaped body and also a shaped body comprising a composition according to the invention.

Glass fiber-reinforced thermoplastic polyurethanes are known per se. They are high-performance materials which combine excellent mechanical properties with very low coefficients of thermal expansion. These materials can withstand high stresses and are used in a variety of applications.

Good glass fiber-reinforced thermoplastic polyurethanes can, for example, be made from MDI-based thermoplastic polyurethanes. The MDI-based hard phase results in very good mechanical properties.

Polyether-based glass fiber-reinforced TPUs which have very high impact toughnesses, especially at low temperatures, are also of interest. These materials are used for various functional components in sports articles such as ski boots and skis.

However, very stiff materials having E moduli of greater than 10 000 MPa are required for some applications. Suitable materials are, however, very difficult to produce since firstly very stiff TPU starting materials are required and secondly very high degrees of fill of glass fibers have to be achieved.

It was therefore an object of the present invention to provide reinforced thermoplastic polyurethanes which have a high stiffness. Furthermore, the thermoplastic polyurethanes should have good mechanical properties and good low-temperature properties and be able to be processed readily.

This object is achieved according to the invention by a composition comprising
(a) a thermoplastic polyurethane (TPU-1) obtained or obtainable by reaction of a polyisocyanate composition (IZ) with a polyol composition (PZ), wherein the polyol composition (PZ) comprises at least one polyol (P1), a chain extender (KV1) and a chain extender (KV2); and
(b) a filler (F1).

It has surprisingly been found that the inventive combination of the thermoplastic polyurethane used and the filler gives compositions which have an improved property profile. Thus, the melting range of the very stiff TPU can firstly be optimized by the use of the specific polyol composition according to the invention. It has been found that the addition of a second chain extender in the synthesis of the very stiff TPU gives starting materials by means of which glass fiber-reinforced TPUs having E moduli of more than 10 000 MPa can be produced.

The composition according to the invention comprises at least one filler (F1) and a thermoplastic polyurethane (TPU-1). The thermoplastic polyurethane (TPU-1) is obtained or obtainable in the context of the present invention by reaction of a polyisocyanate composition (IZ) with a polyol composition (PZ), wherein the polyol composition (PZ) comprises at least one polyol (P1), a chain extender (KV1) and a chain extender (KV2).

Thermoplastic polyurethanes per se are known. They are usually produced by reaction of isocyanates and isocyanate-reactive compounds and chain extenders, optionally in the presence of at least one catalyst and/or customary auxiliaries and/or additives. Isocyanates, isocyanate-reactive compounds and chain extenders are also referred to individually or collectively as formative components.

According to the invention, the thermoplastic polyurethane (TPU-1) is obtainable by reaction of a polyisocyanate composition (IZ) with a polyol composition (PZ). The polyol composition (PZ) comprises at least one polyol (P1), a chain extender (KV1) and a chain extender (KV2). The polyol composition can, for the purposes of the present invention, also comprise further polyols.

As chain extenders (KV1) and (KV2), it is possible to use generally known aliphatic, araliphatic, aromatic and/or cycloaliphatic compounds having a molecular weight, preferably average molecular weight, of from 50 g/mol to 499 g/mol, preferably 2-functional compounds. Preference is given to, for example, alkanediols having from 2 to 10 carbon atoms in the alkylene radical, preferably 1,4-butanediol, 1,6-hexanediol and/or dialkylene, trialkylene, tetraalkylene, penta-alkylene, hexaalkylene, heptaalkylene, octaalkylene, nonaalkylene and/or decaalkylene glycols having from 3 to 8 carbon atoms, more preferably unbranched alkanediols, in particular 1,3-propanediol, 1,4-butanediol and 1,6-hexanediol.

In a further embodiment, the present invention accordingly also provides a composition as described above, wherein the chain extender (KV1) and/or the chain extender (KV2) is selected from the group consisting of 1,2-ethanediol, 1,3-propanediol, 1,4-butanediol and 1,6-hexanediol, diethylene glycol, triethylene glycol, hydroquinone bis-2-hydroxyethyl ether and bis(2-hydroxyethyl) terephthalate.

In the context of the present invention, the chain extender (KV1) is more preferably selected from the group consisting of 1,2-ethanediol, 1,3-propanediol, 1,4-butanediol and 1,6-hexanediol. In a further embodiment, the present invention accordingly also provides a composition as described above, wherein the chain extender (KV1) is 1,4-butanediol.

In the context of the present invention, preference is given to using 1,3-propanediol or 1,6-hexanediol as chain extender (KV2), with further preference being given to using 1,3-propanediol as chain extender (KV2). In a further embodiment, the present invention accordingly provides a thermoplastic polyurethane as described above, wherein the chain extender (KV2) is 1,3-propanediol.

It is also possible according to the invention for a polyhydric alcohol, for example propanediol and/or a further diol, which has been at least partially obtained from renewable raw materials to be used. In this case, it is possible for the polyhydric alcohol to have been obtained partially or entirely from renewable raw materials. According to the invention, at least one of the polyhydric alcohols used can be obtained at least partially from renewable raw materials.

What is known as bio-1,3-propanediol can be obtained, for example, from maize and/or sugar. A further possibility is conversion of glycerol wastes from biodiesel production. In a further preferred embodiment of the invention, the polyhydric alcohol is 1,3-propanediol which has been obtained at least partially from renewable raw materials.

In a further embodiment, the present invention accordingly provides a composition as described above, wherein the thermoplastic polyurethane is based to an extent of at least 30% on renewable raw materials. A suitable method of determination is, for example, the C14 method.

The mixing ratio of the chain extenders (KV1) and (KV2) used can vary within wide ranges. Preference is given to using the chain extenders (KV1) and (KV2) in a ratio in the range from 75:25 to 99:1.

According to the invention, further chain extenders can also be used in the polyol composition.

According to the invention, the polyol composition (PZ) comprises at least the polyol (P1) as isocyanate-reactive compound. For the purposes of the present invention, it is in principle possible to use all polyols which are suitable per se, for example polyesterols, polyetherols and/or polycarbonate diols. For example, the polyol used can have a molecular weight (Mn) in the range from 500 g/mol to 8000 g/mol, and preferably has an average functionality in respect of isocyanates of from 1.8 to 2.3, preferably from 1.9 to 2.2, in particular 2. The number average molecular weight is determined in accordance with DIN 55672-1, unless indicated otherwise.

The polyol (P1) used preferably has a molecular weight in the range from 600 to 2000 dalton, more preferably a molecular weight in the range from 750 to 1500 dalton, in particular a molecular weight of about 1000 dalton.

As polyesterols, it is possible to use polyesters based on diacids and diols. As diols, preference is given to using diols having from 2 to 10 carbon atoms, for example ethanediol, butanediol or hexanediol, in particular 1,4-butanediol, or mixtures thereof. As diacids, it is possible to use all known diacids, for example linear or branched diacids having from 4 to 12 carbon atoms or mixtures thereof.

Furthermore, polyether polyols, for example polyether polyols based on generally known starter substances and customary alkylene oxides, preferably ethylene oxide, propylene oxide and/or butylene oxide, more preferably polyetherols based on 1,2-propylene oxide and ethylene oxide and in particular polyoxytetramethylene glycols, can be used for the purposes of the present invention. The advantage of the polyether polyols is, inter alia, the relatively high hydrolysis stability.

Polyetherols having a low degree of unsaturation are also suitable. For the purposes of this invention, polyols having a low degree of unsaturation are, in particular, polyether alcohols having a content of unsaturated compounds of less than 0.02 meq/g, preferably less than 0.01 meq/g. Such polyether alcohols are usually prepared by addition of alkylene oxides, in particular ethylene oxide, propylene oxide and mixtures thereof, onto the above-described diols or triols in the presence of high-activity catalysts.

Such high-activity catalysts are preferably cesium hydroxide and multimetal cyanide catalysts, also referred to as DMC catalysts. One DMC catalyst which is frequently and preferably used is zinc hexacyanocobaltate. The DMC catalyst can be left in the polyether alcohol after the reaction, but is usually removed, for example by sedimentation or filtration.

Furthermore, polytetrahydrofurans, for example polytetrahydrofurans having an average molecular weight Mn in the range from 400 to 1800 g/mol, preferably polytetrahydrofurans having an average molecular weight Mn in the range from 600 to 1500 g/mol, more preferably polytetrahydrofurans having an average molecular weight Mn in the range from 750 to 1250 g/mol, for example in the range from 900 to 1100 g/mol, can be used for the purposes of the present invention.

It has been found that compositions which have a particularly advantageous property profile are obtained particularly when using polyols having an average molecular weight in the range from 900 to 1100 g/mol. Thus, the compositions according to the invention firstly have a low melting point and secondly have good low-temperature properties.

However, in the context of the present invention the polyol composition can comprise not only the polyol (P1) and the chain extenders (KV1) and (KV2) but also further isocyanate-reactive compounds. For example, the polyol composition can comprise further polyols having an average molecular weight Mn in the range from 800 to 1200 g/mol.

Suitable polycarbonate diols are, for example, polycarbonate diols which are based on alkanediols. Suitable polycarbonate diols are strictly bifunctional OH-functional polycarbonate diols, preferably strictly bifunctional OH-functional aliphatic polycarbonate diols. Suitable polycarbonate diols are based, for example, on 1,4-butanediol, 1,5-pentanediol or 1,6-hexanediol, in particular 1,4-butanediol, 1,5-pentanediol, 1,6-hexanediol, 3-methylpentane-(1,5)-diol, or mixtures thereof, particularly preferably 1,4-butanediol, 1,5-pentanediol, 1,6-hexanediol or mixtures thereof. In the context of the present invention, preference is given to using polycarbonate diols based on 1,4-butanediol and 1,6-hexanediol, polycarbonate diols based on 1,5-pentanediol and 1,6-hexanediol, polycarbonate diols based on 1,6-hexanediol and mixtures of two or more of these polycarbonate diols. Suitable polycarbonate diols have, for example, an average molecular weight Mn in the range from 800 to 1200 g/mol.

It has been found that compositions which are suitable for applications which require good hydrolysis resistance and good aging resistance are obtained when using polycarbonate diols. Thus, the compositions of the invention have not only good low-temperature properties but also high hydrolysis resistance and good aging resistance when polycarbonate diols are used as polyols.

A polyetherol is preferably used as polyol (P1) in the context of the present invention.

In a further embodiment, the present invention accordingly also provides a composition as described above, wherein the polyol (P1) is a polyether polyol.

In the context of the present invention, the isocyanate composition (IZ) is used in the production of the thermoplastic polyurethane (TPU-1). The isocyanate composition comprises at least one polyisocyanate, preferably at least one diisocyanate.

For the purposes of the present invention, the organic isocyanates customarily used are suitable in principle. As organic isocyanates, it is possible to use aliphatic, cycloaliphatic, araliphatic and/or aromatic isocyanates, more preferably trimethylene, tetramethylene, pentamethylene, hexamethylene, heptamethylene and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethyl-cyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), naphthylene 1,5-diisocyanate (NDI), tolylene 2,4- and/or 2,6-diisocyanate (TDI), dimethylbiphenyl 3,3′-diisocyanate, 1,2-diphenylethane diisocyanate and/or phenylene diisocyanate. Particular preference is given to using only 4,4′-MDI.

In a further embodiment, the present invention accordingly provides a composition as described above, wherein the thermoplastic polyurethane is based on diphenylmethane 4,4′-diisocyanate.

Further suitable aliphatic isocyanates are, for example, hexamethylene diisocyanate (HDI) or 1-isocyanato-4-[(4-isocyanatocyclohexyl)methyl]cyclohexane (H12MDI).

Particularly preferred isocyanates are, according to the invention, hexamethylene diisocyanate (HDI), diphenylmethane 2,2′-, 2,4′- and/or 4,4′-diisocyanate (MDI) and tolylene 2,4- and/or 2,6-diisocyanate (TDI) or 1-isocyanato-4-[(4-isocyanatocyclohexyl)methyl]cyclohexane (H12MDI), with diphenylmethane 2,2′-, 2,4′- and/or 4,4′-diisocyanate (MDI) being particularly preferred, in particular diphenylmethane 4,4′-diisocyanate.

In a further embodiment, the present invention accordingly also provides a composition as described above, wherein the polyisocyanate composition (IZ) comprises a polyisocyanate (PI) selected from the group consisting of phenylene 1,2-, 1,3- and/or 1,4-diisocyanate, triphenylmethane 4,4′,4″-triisocyanate, naphthylene 1,5-diisocyanate (NDI), tolylene 2,4- and/or 2,6-diisocyanate (TDI), biphenyl 2,4′-, 4,4′- and/or 2,2-diisocyanate, diphenylmethane 2,2′-, 2,4′- and/or 4,4′-diisocyanate (MDI), polyphenylpolymethylene polyisocyanate, xylylene 1,2-, 1,3- and/or 1,4-diisocyanate and m-tetramethylxylylene diisocyanates (TMXDI).

Apart from the isocyanate composition (IZ) and the polyol composition (PZ), further components, for example suitable catalysts or auxiliaries, can be used for producing the thermoplastic polyurethane (TPU1).

Catalysts which, in particular, accelerate the reaction between the NCO groups of the diisocyanates and the hydroxyl groups of the isocyanate-reactive compound and the chain extender are, in a preferred embodiment, tertiary amines, in particular triethylamine, dimethylcyclohexylamine, N-methylmorpholine, N,N′-dimethylpiperazine, 2-(dimethylamino-ethoxy)ethanol, diazabicyclo[2.2.2]octane; in another preferred embodiment, these are organic metal compounds such as titanic esters, iron compounds, preferably iron(III) acetylacetonate, tin compounds, preferably tin diacetate, tin dioctoate, tin dilaurate or the dialkyltin salts of aliphatic carboxylic acids, preferably dibutyltin diacetate, dibutyltin dilaurate, or bismuth salts in which bismuth is preferably present in the oxidation state 2 or 3, in particular 3. Preference is given to salts of carboxylic acids. As carboxylic acids, preference is given to using carboxylic acids having from 6 to 14 carbon atoms, particularly preferably having from 8 to 12 carbon atoms. Examples of suitable bismuth salts are bismuth(III) neodecanoate, bismuth 2-ethyl-hexanoate and bismuth octanoate.

The catalysts are preferably used in amounts of from 0.0001 to 0.1 part by weight per 100 parts by weight of the isocyanate-reactive compound. Preference is given to using tin catalysts, in particular tin dioctoate.

Apart from catalysts, it is also possible to add customary auxiliaries. Mention may be made by way of example of surface-active substances, fillers, further flame retardants, nucleating agents, oxidation stabilizers, lubricants and mold release agents, dyes and pigments, optionally stabilizers, e.g. against hydrolysis, light, heat or discoloration, inorganic and/or organic fillers, reinforcing materials and plasticizers. Suitable auxiliaries and additives may be found, for example, in the Kunststoffhandbuch, volume VII, edited by Vieweg and Hochtlen, Carl Hanser Verlag, Munich 1966 (pp. 103-113).

Suitable production processes for thermoplastic polyurethanes are, for example, disclosed in EP 0 922 552 A1, DE 101 03 424 A1 or WO 2006/072461 A1. Production is usually carried out on a belt plant or a reaction extruder, but can also be carried out on a laboratory scale, for example by manual casting methods. Depending on the materials properties of the components, these are all mixed directly with one another or individual components are premixed and/or prereacted, e.g. to form prepolymers, and only then are subjected to the polyaddition. In a further embodiment, a thermoplastic polyurethane is firstly produced from the formative components, optionally using a catalyst, into which thermoplastic polyurethane auxiliaries can optionally be incorporated. At least one filler is then incorporated into this material and is homogeneously dispersed. The homogeneous dispersion is preferably carried out in an extruder, preferably in a twin-screw extruder. According to the invention, preference is given to adding the filler in portions, for example one part at the intake of the extruder and a further part at a second metering position, for example a side feeder. To set the hardness of the TPU, the amounts of the formative components (b) and (c) used can be varied in a relatively wide molar ratio range, with the hardness usually increasing with increasing content of chain extenders.

According to the invention, the mixing ratio of the components used for producing the thermoplastic polyurethane can vary within a wide range. For example, the chain extenders and the polyol used can be used in a molar mixing ratio in the range from 20:1 to 1:1, preferably in the range from 18:1 to 2:1, more preferably in the range from 17:1 to 3:1, particularly preferably in the range from 15:1 to 4:1.

According to the invention, the mixing ratio of the chain extenders (KV1) and (KV2) used can vary within a wide range. For example, the chain extenders can be used in a molar mixing ratio KV1:KV2 in the range from 20:1 to 3:1, preferably in the range from 15:1 to 4:1, more preferably in the range from 17:1 to 3:1, particularly preferably in the range from 15:1 to 4:1.

The thermoplastic polyurethane used according to the invention preferably has a hardness in the range from 40 D to 90 D, determined in accordance with DIN ISO 7619-1 (Shore hardness test A (3 s)), preferably in the range from 50 D to 90 D, determined in accordance with DIN ISO 7619-1, more preferably in the range from 60 D to 90 D, determined in accordance with DIN ISO 7619-1, particularly preferably in the range from 70 D to 90 D, determined in accordance with DIN ISO 7619-1.

In a further embodiment, the present invention accordingly also provides a composition as described above, wherein the thermoplastic polyurethane has a Shore hardness in the range from 40 D to 90 D, determined in accordance with DIN ISO 7619-1.

To produce the thermoplastic polyurethanes of the invention, the formative components are preferably reacted in the presence of catalysts and optionally auxiliaries and/or additives in such amounts that the equivalence ratio of NCO groups of the diisocyanates to the sum of the hydroxyl groups of the further formative components is 0.9-1.1:1, preferably 0.95-1.05:1 and in particular about 0.95-1.00:1.

The composition of the invention comprises the at least one thermoplastic polyurethane (TPU1) in an amount in the range from 40% by weight to 60% by weight, based on the total composition, in particular in the range from 45% by weight to 55% by weight, based on the total composition, preferably in the range from 48% by weight to 52% by weight, in each case based on the total composition.

In a further embodiment, the present invention therefore provides a composition as described above, wherein the proportion of the thermoplastic polyurethane in the composition is in the range from 40% by weight to 60% by weight, based on the total composition.

Here, the sum of all components of the composition is in each case 100% by weight.

Preference is given according to the invention to using thermoplastic polyurethanes in which the thermoplastic polyurethane has an average molecular weight (M_{W}) in the range from 50 000 to 500 000 Da. The upper limit to the average molecular weight (M_{W}) of the thermoplastic polyurethanes is generally determined by the processability and also the desired property spectrum. More preferably, the thermoplastic polyurethane has an average molecular weight (M_{W}) in the range from 50 000 to 250 000 Da, particularly preferably in the range from 50 000 to 150 000 Da.

According to the invention, it is also possible for the composition to comprise two or more thermoplastic polyurethanes which differ, for example, in respect of their average molecular weight or in respect of their chemical composition.

The thermoplastic polyurethane can be produced discontinuously or continuously by known methods, for example using reaction extruders or the belt process, by the one-shot or prepolymer process, preferably by the one-shot process. In these processes, the components to be reacted can be mixed with one another in succession or simultaneously, with the reaction commencing immediately. In the extruder process, the formative components are introduced individually or as a mixture into the extruder, e.g. preferably at temperatures of from 100° C. to 280° C., more preferably reacted at from 140° C. to 250° C., and the polyurethane obtained is then extruded, cooled and pelletized.

The composition of the invention further comprises a filler (F1). According to the invention, the chemical nature and the shape of the filler (F1) can vary within wide ranges, as long as sufficient compatibility with the thermoplastic polyurethane (TPU-1) is ensured. Here, the filler (F1) should be selected so that the shape and particle size of the filler allow sufficient miscibility and uniform dispersion in the composition.

Suitable fillers are, for example, glass fibers, glass spheres, carbon fibers, aramid fibers, potassium titanate fibers, fibers composed of liquid-crystal polymers, organic fibrous fillers or inorganic reinforcing materials. Organic fibrous fillers are, for example, cellulose fibers, hemp fibers, sisal or kenaf. Inorganic reinforcing materials are, for example, ceramic fillers such as aluminum nitride and boron nitride, or mineral fillers such as asbestos, talc, wollastonite, microvite, silicates, chalk, calcined kaolins, mica and quartz flour. According to the invention, the filler (F1) is preferably selected from the group consisting of glass fibers, carbon fibers, aramid fibers, potassium titanate fibers, fibers composed of liquid-crystal polymers, metal fibers, polyester fibers, polyamide fibers, organic fibrous fillers and inorganic fibrous fillers.

In a further embodiment, the present invention accordingly also provides a composition as described above, wherein the filler (F1) is selected from the group consisting of glass fibers, carbon fibers, aramid fibers, potassium titanate fibers, fibers composed of liquid-crystal polymers, metal fibers, polyester fibers, polyamide fibers, organic fibrous fillers and inorganic fibrous fillers.

For the purposes of the present invention, preference is given to fibrous fillers. In a further embodiment, the present invention accordingly also provides a composition as described above, wherein the filler (F1) is fibrous.

The dimensions of the fillers used can vary within customary ranges. The filler used preferably has a length in the range from 3 mm to 4 mm and a diameter in the range from 1 μm to 20 μm, in each case determined in accordance with ASTM D578-98. In a further embodiment, the present invention accordingly also provides a composition as described above, wherein the filler (F1) has a length in the range from 3 mm to 4 mm and a diameter in the range from 1 μm to 20 μm, in each case determined in accordance with ASTM D578-98.

The fillers, for example the fibrous fillers, can have been pretreated, for example with a silane compound, to give better compatibility with the thermoplastic polymer.

Preference is given to using inorganic fibrous fillers. When inorganic fibrous fillers are used, a relatively large reinforcing effect and a relatively high heat distortion resistance are found.

According to the invention, the composition can also comprise two or more fillers.

The proportion of the filler (F1) in the composition is, for example, in the range from 40 to 60% by weight based on the total composition, preferably in the range from 45 to 55% by weight based on the total composition, more preferably in the range from 48 to 52% by weight based on the total composition.

In a further embodiment, the present invention accordingly also provides a composition as described above, wherein the filler (F1) is comprised in an amount in the range from 40 to 60% by weight based on the total composition.

According to the invention, the composition can also comprise further components, for example mold release agents, UV protection, antioxidant or color pigments, in addition to the thermoplastic polyurethane (TPU1) and the filler (F1).

According to a further aspect, the present invention also provides a process for producing a composition, which comprises the step

(i) mixing of the components
(a) a thermoplastic polyurethane (TPU-1) obtained or obtainable by reaction of a polyisocyanate composition (IZ) with a polyol composition (PZ), wherein the polyol composition (PZ) comprises at least one polyol (P1), a chain extender (KV1) and a chain extender (KV2); and
(b) a filler (F1).

As regards the preferred embodiments, reference is made to what has been said above in respect of the components which are preferably used.

Suitable methods for producing the composition are known per se to a person skilled in the art. For the purposes of the present invention, methods known per se are usually used for compounding.

For example, the composition can be produced in a manner known per se in an extruder, for example in a twin-screw extruder. Preference is given according to the invention to adding the filler in portions, for example one part at the intake of the extruder and a further part at a second metering position, for example a side feeder. The temperature here is preferably in the range from 160 to 230° C. For the purposes of the present invention, the extruder can, for example, be operated at a speed of rotation in the range from 150 to 300 revolutions per minute.

The present invention further provides a composition obtained or obtainable by a process according to the invention.

The present invention also provides for the use of the composition of the invention or of a composition obtained or obtainable by a process according to the invention for producing a shaped body.

Production is preferably effected from pellets, by injection molding, calendering, powder sintering, or extrusion and/or by additional foaming of the composition of the invention.

The present invention further provides, according to a further aspect, shaped bodies comprising a composition according to the invention or a composition obtained or obtainable by a process according to the invention.

The present invention also provides for the use of the composition of the invention as described above for producing shaped bodies, for example parts of a shoe or parts of ski boots.

Further embodiments of the present invention are indicated in the claims and the examples. It goes without saying that the abovementioned features and the features explained below of the object/process according to the invention or the uses according to the invention can be employed not only in the combination indicated in each case but also in other combinations, without going outside the scope of the invention. Thus, for example, the combination of a preferred feature with a particularly preferred feature, or of a feature not characterized in more detail with a particularly preferred feature, etc., is implicitly encompassed even when this combination is not expressly mentioned.

Illustrative embodiments of the present invention are listed below, but these do not restrict the present invention. In particular, the present invention also encompasses embodiments which are obtained from the back-references indicated below and thus combinations.
1. Composition comprising
   (a) a thermoplastic polyurethane (TPU-1) obtained or obtainable by reaction of a polyisocyanate composition (IZ) with a polyol composition (PZ), wherein the polyol composition (PZ) comprises at least one polyol (P1), a chain extender (KV1) and a chain extender (KV2); and
   (b) a filler (F1).
2. Composition according to embodiment 1, wherein the chain extender (KV1) and/or the chain extender (KV2) is selected from the group consisting of 1,2-ethanediol, 1,3-propanediol, 1,4-butanediol and 1,6-hexanediol, diethylene glycol, triethylene glycol, hydroquinone bis-2-hydroxyethyl ether and bis(2-hydroxyethyl) terephthalate.
3. Composition according to embodiment 1 or 2, wherein the chain extender (KV1) is 1,4-butanediol.
4. Composition according to any of embodiments 1 to 3, wherein the chain extender (KV1) is 1,4-butanediol and the chain extender (KV2) is 1,3-propanediol.
5. Composition according to any of embodiments 1 to 4, wherein the polyol (P1) is a polyether polyol.
6. Composition comprising
   (a) a thermoplastic polyurethane (TPU-1) obtained or obtainable by reaction of a polyisocyanate composition (IZ) with a polyol composition (PZ), wherein the polyol composition (PZ) comprises at least one polyol (P1), a chain extender (KV1) and a chain extender (KV2); and
   (b) a filler (F1),
   wherein the chain extender (KV1) is 1,4-butanediol and the chain extender (KV2) is 1,3-propanediol and the polyol (P1) is a polyether polyol.
7. Composition according to any of embodiments 1 to 6, wherein the polyisocyanate composition (IZ) comprises a polyisocyanate (PI) selected from the group consisting of phenylene 1,2-, 1,3- and/or 1,4-diisocyanate, triphenylmethane 4,4′,4″-triisocyanate, naphthylene 1,5-diisocyanate (NDI), tolylene 2,4- and/or 2,6-diisocyanate (TDI), biphenyl 2,4′-, 4,4′- and/or 2,2-diisocyanate, diphenylmethane 2,2′-, 2,4′- and/or 4,4′-diisocyanate (MDI), polyphenylpolymethylene polyisocyanate, xylylene 1,2-, 1,3- and/or 1,4-diisocyanate and m-tetramethylxylylene diisocyanates (TMXDI).
8. Composition according to any of embodiments 1 to 7, wherein the filler (F1) is fibrous.
9. Composition according to any of embodiments 1 to 8, wherein the filler (F1) is selected from the group consisting of glass fibers, carbon fibers, aramid fibers, potassium titanate fibers, fibers composed of liquid-crystal polymers, metal fibers, polyester fibers, polyamide fibers, organic fibrous fillers and inorganic fibrous fillers.
10. Composition according to any of embodiments 1 to 9, wherein the filler (F1) has a length in the range from 3 mm to 4 mm and a diameter in the range from 1 μm to 20 μm, in each case determined in accordance with ASTM D578-98.
11. Composition comprising
   (a) a thermoplastic polyurethane (TPU-1) obtained or obtainable by reaction of a polyisocyanate composition (IZ) with a polyol composition (PZ), wherein the polyol composition (PZ) comprises at least one polyol (P1), a chain extender (KV1) and a chain extender (KV2); and
   (b) a filler (F1),
   wherein the chain extender (KV1) is 1,4-butanediol and the chain extender (KV2) is 1,3-propanediol and the polyol (P1) is a polyether polyol and
   the filler (F1) is fibrous and has a length in the range from 3 mm to 4 mm and a diameter in the range from 1 μm to 20 μm, in each case determined in accordance with ASTM D578-98.
12. Composition according to any of embodiments 1 to 11, wherein the filler (F1) is comprised in an amount in the range from 40 to 60% by weight based on the total composition.
13. Composition comprising
   (a) a thermoplastic polyurethane (TPU-1) obtained or obtainable by reaction of a polyisocyanate composition (IZ) with a polyol composition (PZ), wherein the polyol composition (PZ) comprises at least one polyol (P1), a chain extender (KV1) and a chain extender (KV2); and
   (b) a filler (F1),
   wherein the chain extender (KV1) is 1,4-butanediol and the chain extender (KV2) is 1,3-propanediol and the polyol (P1) is a polyether polyol and
   the filler (F1) is comprised in an amount in the range from 40 to 60% by weight based on the total composition.
14. Composition according to any of embodiments 1 to 13, wherein the thermoplastic polyurethane has a Shore hardness in the range from 40 D to 90 D, determined in accordance with DIN ISO 7619-1, preferably 70 D-90 D.
15. Process for producing a composition, which comprises the step
   (i) mixing of the components
      (a) a thermoplastic polyurethane (TPU-1) obtained or obtainable by reaction of a polyisocyanate composition (IZ) with a polyol composition (PZ), wherein the polyol composition (PZ) comprises at least one polyol (P1), a chain extender (KV1) and a chain extender (KV2); and
      (b) a filler (F1).
16. Process according to embodiment 15, wherein the chain extender (KV1) and/or the chain extender (KV2) is selected from the group consisting of 1,2-ethanediol, 1,3-propanediol, 1,4-butanediol and 1,6-hexanediol, diethylene glycol, triethylene glycol, hydroquinone bis-2-hydroxyethyl ether and bis(2-hydroxyethyl) terephthalate.
17. Process according to embodiment 15 or 16, wherein the chain extender (KV1) is 1,4-butanediol.
18. Process according to any of embodiments 15 to 17, wherein the polyol (P1) is a polyether polyol.
19. Process according to any of embodiments 15 to 18, wherein the polyisocyanate composition (IZ) comprises a polyisocyanate (PI) selected from the group consisting of phenylene 1,2-, 1,3- and/or 1,4-diisocyanate, triphenylmethane 4,4′,4″-triisocyanate, naphthylene 1,5-diisocyanate (NDI), tolylene 2,4- and/or 2,6-diisocyanate (TDI), biphenyl 2,4′-, 4,4′- and/or 2,2-diisocyanate, diphenylmethane 2,2′-, 2,4′- and/or 4,4′-diisocyanate (MDI), polyphenylpolymethylene polyisocyanate, xylylene 1,2-, 1,3- and/or 1,4-diisocyanate and m-tetramethylxylylene diisocyanates (TMXDI).
20. Process according to any of embodiments 15 to 19, wherein the filler (F1) is fibrous.
21. Process according to any of embodiments 15 to 20, wherein the filler (F1) is selected from the group consisting of glass fibers, carbon fibers, aramid fibers, potassium titanate fibers, fibers composed of liquid-crystal polymers, metal fibers, polyester fibers, polyamide fibers, organic fibrous fillers and inorganic fibrous fillers.
22. Process according to any of embodiments 15 to 21, wherein the filler (F1) has a length in the range from 3 mm to 4 mm and a diameter in the range from 1 μm to 20 μm, in each case determined in accordance with ASTM D578-98.
23. Process according to any of embodiments 15 to 22, wherein the filler (F1) is comprised in an amount in the range from 40 to 60% by weight based on the total composition.
24. Process according to any of embodiments 15 to 23, wherein the thermoplastic polyurethane has a Shore hardness in the range from 40 D to 90 D, determined in accordance with DIN ISO 7619-1, preferably 70 D-90 D.
25. Composition obtained or obtainable by a process according to any of embodiments 15 to 24.
26. Use of a composition according to any of embodiments 1 to 14 or of a composition obtained or obtainable by a process according to any of embodiments 15 to 24 for producing a shaped body.
27. Shaped body comprising a composition according to any of embodiments 1 to 14 or a composition obtained or obtainable by a process according to any of embodiments 15 to 24.

The following examples serve to illustrate the invention but do not restrict the subject matter of the present invention in any way.

### EXAMPLES

### 1. Materials Used

Chopvantage HP3550 EC10-3,8: glass fiber from PPG Industries Fiber Glass, Energieweg 3, 9608 PC Westerbroek, the Netherlands, E glass, filament diameter 10 μm, length 3.8 mm.
TPU 1: TPU having a Shore hardness of 60 D, based on polytetrahydrofuran (PTHF) having a molecular weight (Mn) of 1000 dalton, 1,4-butanediol, MDI.
TPU 2: TPU having a Shore hardness of 83 D, based on polytetrahydrofuran (PTHF) having a molecular weight (Mn) of 1000 dalton, 1,4-butanediol, MDI.
TPU 3: TPU having a Shore hardness of 83 D, based on polytetrahydrofuran (PTHF) having a molecular weight (Mn) of 1000 dalton, 1,4-butanediol, 1,3-propanediol, MDI.
TPU 4: glass fiber-filled TPU having a Shore hardness of 70 D and produced by compounding 48% of the glass fibers Chopvantage HP3550 EC10-3,8 into TPU 1.
TPU 5: glass fiber-filled TPU having a Shore hardness of 75 D and produced by compounding 48% of the glass fibers Chopvantage HP3550 EC10-3,8 into TPU 2 (not producible, see table 4).
TPU 6: glass fiber-filled TPU having a Shore hardness of 75 D and produced by compounding 48% of the glass fibers Chopvantage HP3550 EC10-3,8 into TPU 3.

### 2. Production Examples

2.1 Production by the Manual Casting Process (TPU 1-3)
The amount of polyol and of chain extenders specified in the basic formulation (table 1) is weighed into a tinplate can and briefly blanketed with nitrogen. The can is closed with a lid and heated to about 90° C. in an oven.
A further oven for heat treating the polyurethane sheet is preheated to 80° C. The Teflon dish is placed on the hotplate and this is set to 125° C.
The calculated amount of liquid isocyanate is determined by volumetric measurement. For this purpose, the liquid isocyanate (the volume of MDI is measured at a temperature of about 48° C.) is weighed into a PE beaker and within 10 s poured out into a PE beaker.
The beaker which has been emptied in this way is subsequently tared and filled with the calculated amount of isocyanate. In the case of MDI, this is stored in the oven at about 48° C.
Additives such as hydrolysis protection, antioxidant, etc., which are present as solids at RT are weighed in directly.
The preheated polyol is placed on a jack under the stirrer at rest. The reaction vessel is subsequently lifted by means of the jack until the stirrer blades are completely immersed in the polyol.
Before the stirrer motor is switched on, it is absolutely necessary to ensure that the rotational speed regulator is in the zero position. The speed of rotation is subsequently slowly increased, so that good mixing without air being stirred in is ensured.
Additives such as antioxidants are subsequently added to the polyol.
The temperature of the reaction mixture is carefully set to 80° C. by means of a hot air blower.
If necessary, catalyst is metered into the reaction mixture by means of a microliter syringe before the addition of isocyanate. The addition of isocyanate is then carried out at 80° C. by introducing the previously volumetrically measured amount into the reaction mixture over a period of 10 s. The weight is monitored by backweighing. Deviations of more than/less than 0.2 g from the formulation amount are documented. The stopwatch is started with the addition of the isocyanate. When the temperature has reached 110° C., the reaction mixture is poured out into the Teflon dishes which have been preheated to 125° C.
10 minutes after the stopwatch has been started, the polyurethane sheet is taken from the hotplate and subsequently stored at 80° C. for 15 hours in the oven. The cooled polyurethane sheet is comminuted in the cutter mill. The granulated material is then dried at 110° C. for 3 hours and stored dry.
This process can in principle be carried over to the reaction extruder or the belt process.

TABLE 1
Formulations of the TPUs 1-3

| | TPU 1 | TPU 2 | TPU 3 |
|---|---|---|---|
| PTHF 1000 [g] | 393.2 | 100 | 100 |
| Lupranat MET [g] | 471.8 | 395.5 | 395.5 |
| 1,4-Butanediol [g] | 135.0 | 133.4 | 121.7 |
| 1,3-Propanediol [g] | — | — | 9.8 |

TABLE 2
Properties of the TPUs 1-3

| | | TPU 1 | TPU 2 | TPU 3 |
|---|---|---|---|---|
| Tensile strength | DIN 53504-S2 | 50 | 70 | 67 |
| [MPa] | | | | |
| Elongation at break | DIN 53504-S2 | 400 | 160 | 170 |
| [%] | | | | |
| Shore hardness [D] | DIN ISO 7619-1 | 60 | 85 | 83 |
| | (3 s) | | | |
| E modulus [MPa] | DIN EN ISO 527 | 200 | 2000 | 2000 |

2.2 Production of TPUs 4-6
Table 3 below shows compositions in which the individual starting materials are reported in parts by weight (pbw). The mixtures were in each case produced using a twin-screw extruder model ZE 40 A from Berstorff having a process part length of 35 D divided into 10 barrel sections. Continuous pelletization was used.

TABLE 3
Formulations of the TPUs 1-3

| | | | TPU 6 (example |
|---|---|---|---|
| | | | according to the |
| | TPU 4 (CE) | TPU 5 (CE) | invention) |
| TPU 1 | 52 | | |
| TPU 2 | | 52 | |
| TPU 3 | | | 52 |
| Chopvantage | 48 | 48 | 48 |
| HP3550 EC10-3,8 | | | |

TABLE 4
Properties of the TPUs 4-6

| | | | | TPU 6 (example |
|---|---|---|---|---|
| | | | | according to the |
| | | TPU 4 (CE) | TPU 5 (CE) | invention) |
| Tensile strength | DIN 53504-S2 | 93 | Not | 244 |
| [MPa] | | | producible | |
| Elongation at break | DIN 53504-S2 | 8 | | 3 |
| [%] | | | | |
| E modulus [MPa] | DIN EN ISO 527 | 4080 | | 18 300 |

### 3. Results

Processing of TPU 2 is not possible. The material has a very high melting range, and the production of the glass fiber compound is not possible.
TPU 4 is producible, but the E modulus is only 4080 MPa.
Surprisingly, TPU 6 is producible. The E modulus is 18 300 MPa.

### 4. Measurement Methods

Shore hardness A: DIN ISO 7619-1, Shore hardness test A (3 s)
Tensile strength: DIN EN ISO 527
Elongation at break: DIN EN ISO 527
Tear propagation resistance: DIN ISO 34-1, B (b

### REFERENCES CITED

Kunststoffhandbuch, volume VII, edited by Vieweg and Hochtlen, Carl Hanser Verlag, Munich 1966 (pages 103-113)
EP 0 922 552 A1
DE 101 03 424 A1
WO 2006/072461 A1

1-14. (canceled)

15. A composition, comprising:
(a) a thermoplastic polyurethane comprising, in reacted form, a polyisocyanate composition comprising a polyol composition comprising a polyol, a first chain extender, and a second chain extender, the first and second chain extenders being in a first:second molar mixing ratio in a range of from 20:1 to 3:1; and
(b) a filler that is fibrous.

16. The composition of claim 15, wherein the first chain extender and/or the second chain extender is selected from the group consisting of 1,2-ethanediol, 1,3-propanediol, 1,4-butanediol, 1,6-hexanediol, diethylene glycol, triethylene glycol, hydroquinone bis-2-hydroxyethyl ether, and bis(2-hydroxyethyl) terephthalate.

17. The composition of claim 15, wherein the first chain extender is 1,4-butanediol.

18. The composition of claim 15, wherein the polyol is a polyether polyol.

19. The composition of claim 15, wherein the polyisocyanate composition comprises phenylene 1,2-diisocyanate, phenylene 1,3-diisocyanate, phenylene 1,4-diisocyanate, triphenylmethane 4,4′,4″-triisocyanate, naphthylene 1,5-diisocyanate, tolylene 2,4-diisocyanate, tolylene 2,6-diisocyanate, biphenyl 2,4′-diisocyanate, biphenyl 4,4′-diisocyanate, biphenyl 2,2-diisocyanate, diphenylmethane 2,2′-diisocyanate, diphenylmethane 2,4′-diisocyanate, diphenylmethane 4,4′-diisocyanate, polyphenylpolymethylene polyisocyanate, xylylene 1,2-diisocyanate, xylylene 1,3-diisocyanate, xylylene 1,4-diisocyanate, and/or m-tetramethylxylylene diisocyanate.

20. The composition of claim 15, wherein the filler is organic.

21. The composition of claim 15, wherein the filler is inorganic.

22. The composition of claim 15, wherein the filler is selected from the group consisting of glass fiber, carbon fiber, aramid fiber, potassium titanate fiber, liquid-crystal polymer fiber, metal fiber, polyester fiber, and/or polyamide fiber.

23. The composition of claim 15, wherein the filler has a length in a range of from 3 to 4 mm and a diameter in a range of from 1 to 20 μm, in each case determined in accordance with ASTM D578-98.

24. The composition of claim 15, wherein the filler is comprised in an amount in a range of from 40 to 60 wt. %, based on total composition weight.

25. The composition of claim 15, wherein the thermoplastic polyurethane has a Shore hardness in a range of from 40 D to 90 D, determined in accordance with DIN ISO 7619-1.

26. The composition of claim 15, wherein the thermoplastic polyurethane has a Shore hardness in a range of from 70 D to 90 D, determined in accordance with DIN ISO 7619-1.

27. A process for producing a composition, the method comprising:
mixing (a) a thermoplastic polyurethane comprising, in reacted form a polyisocyanate composition comprising a polyol composition comprising a polyol, a first chain extender, and a chain extender, the chain extenders being in a first:second molar mixing ratio in a range of from 20:1 to 3:1; and (b) a filler that is fibrous.

28. A composition obtained by the process of claim 27.

29. A shaped body, comprising the composition of claim 15.
